(19) United States
(12) Patent Application Publication
(10) Pub. No.: US 2015/0007623 A1
(43) Pub. Date: Jan. 8, 2015

(54) ADVANCED LOCKABLE LATCH APPARATUS AND A METHOD OF USING SAME

(71) Applicant: SAAD AHMED S ALGHAMDI, Jubail Industrial City (SA)

(72) Inventor: SAAD AHMED S ALGHAMDI, Jubail Industrial City (SA)

(21) Appl. No.: 14/288,175

(22) Filed: May 27, 2014

Related U.S. Application Data
(60) Provisional application No. 61/828,652, filed on May 29, 2013.

(51) Int. Cl. E05C 1/00; E05B 41/00

(52) U.S. Cl. CPC E05C 1/00; E05B 41/00
USPC 70/344; 292/137

(57) ABSTRACT

The present invention relates generally to a lockable latch apparatus and a method of using same. More particularly, the invention encompasses a lockable latch that can be locked into place using a key to prevent it from sliding or being opened. The invention also provides a method of using the inventive lockable latch where the lockable latch has color coding or indicia to indicate its position within the latch assembly. The housing could also have an opening to receive and securely hold the latch handle inside the housing when in the locked position, and wherein from that locked position the latch handle can only be released or ejected using a key.

### CROSS-REFERENCE TO RELATED APPLICATION

The instant patent application claims priority to and the benefit of pending U.S. Provisional Patent Application Ser. No. 61/828,652, filed on May 29, 2013, titled “Advanced Lockable Latch,” the entire disclosure of which provisional application is incorporated herein by reference.

### FIELD OF THE INVENTION

The present invention relates generally to a lockable latch apparatus and a method of using same. More particularly, the invention encompasses a lockable latch that can be locked into place using a key to prevent it from sliding or being opened. The invention also provides a method of using the inventive lockable latch where the lockable latch has color coding or indicia to indicate its position within the latch assembly. The housing could also have an opening to receive and securely hold the latch handle inside the housing when in the locked position, and wherein from that locked position the latch handle can only be released or ejected using a key.

### BACKGROUND INFORMATION

Latches and locks have been used in the industry for a variety of reasons, and they come in many shapes, sizes, and other physical features and attributes.

U.S. Pat. No. 4,195,867 (William R. Baillie), the entire disclosure of which is incorporated herein by reference, discloses a door latch particularly for use in mobile homes or recreational vehicles. A housing having a channel formed therein is mounted on one surface of a door overlying a passageway therethrough. A spring-loaded slidable latch engagement member is positioned within the channel for operating engagement with a striker plate mounted on the jamb of the frame against which the door abuts when closed. A latch retaining pin is positioned through the housing and has a shaft part extending within the passageway in the door for receipt on the other side of the door surface of an operating knob or handle secured thereon. Rotation of the operating knob actuates the pin to disengage the latch engagement member and thereby unlatch the door. A lockable abutment member may be positioned upon the door surface or an extension part of the housing to block the path of the latch engagement member when moved toward disengagement position and thereby prevent such disengagement. In an alternate embodiment a concealed latch is disclosed in which the latch engagement member has a lateral extension disposed in a space formed in the door and opening to the door edge such that a force applied to the extension member will disengage the latch engagement member.

U.S. Pat. No. 4,930,323 (Yasuharu Terada, et al.), the entire disclosure of which is incorporated herein by reference, discloses a double lockable sliders comprise a pair of first and second sliders reciprocatively mounted on the slide fastener and disposed reversely to each other. When the second pull tab is turned flat against the first pull tab, the engaging projection provided at the distal end and on one surface of the second pull tab comes into the recess formed in one surface of the first pull tab, and the prong provided at one end of the latch member resiliently comes into locking engagement with the indentation formed in one side of the engaging projection. The double lockable sliders further include cam means for imparting to the engaging projection upward motion when the latch member is pulled away from the second slider longitudinally of the slide fastener.

U.S. Pat. No. 5,524,944 (Robert D. W. Berg), the entire disclosure of which is incorporated herein by reference, discloses a lockable latch mechanism for receiving the hasp of a padlock and locking a hinged door to a door jamb to prevent opening of the door when the door is closed and the latch is in engagement with the jamb. The latch includes a sliding latch mounted on the door including a latch plate and a latch bolt. A latch bolt defines a cam surface engagable with the jamb to cam the latch bolt away from the jamb as the door is closed. Biasing springs are utilized to bias the latch bolt outwardly with respect to the latch plate and to bias the latch plate and latch bolt together outwardly with respect to the door jamb. A detent prevents movement between the latch plate and the latch bolt when the latch is mounted on a door and latched behind a door jamb.

U.S. Pat. No. 8,297,667 (Junko Pauken, et al.), the entire disclosure of which is incorporated herein by reference, discloses a lockable latch system includes an anchor bar rigidly connected to a vehicle and a rigid hook operably engaged with the anchor bar. A springboard is disposed on the rigid hook. The springboard is operable between an obstructing position, wherein the springboard prevents disengagement of the rigid hook from the bar and an unobstructing position, wherein the springboard does not prevent disengagement of the rigid hook from the bar. A lock assembly includes a cam operable between an interference position, wherein the cam prevents the springboard from entering the unobstructing position and a non-interference position, wherein the cam does not prevent the springboard from entering the unobstructing position.

U.S. Patent Publication No. 2007/0200356 (Andrew Thornton, et al.), the entire disclosure of which is incorporated herein by reference, discloses a latch has a latch bolt mounted on a rack and a top gear which engages the rack. The top gear can be driven by an idle gear which is disengageable from a drop gear which in turn is engaged with a lockable drive gear upon rotation of a cam disc. Initial rotation of the cam disc disengages the drop gear. Further rotation of the cam disc moves the top gear so as to permit the rack to move the bolt to the unlatched position. The latch can be operated from one side by the rotation of a lock plug in the drive. The other side of the latch has a turnhandle on the cam disc which unlatches the latch even when the drive gear is locked from the outside.

This invention improves on the deficiencies of the prior art and provides an inventive advanced lockable latch apparatus and a method of using same.

### PURPOSES AND SUMMARY OF THE INVENTION

The invention is a novel advanced lockable latch apparatus and a method of using same.

Therefore, one purpose of this invention is to provide an advanced lockable latch that can be used to securely lock a fixture, such as, a window, a door, etc.

Another purpose of this invention is to provide a locking mechanism for a latch that has a key to either lock or open the locking mechanism.

Yet another purpose of this invention is to provide a locking mechanism that has a window to display features that are on a latch slider.

Therefore, in one aspect this invention comprises a locking apparatus, comprising;
(a) a male section having a housing and a channel for a slider;
(b) a female section having a housing and an opening to receive a portion of said slider; and
(c) a locking mechanism to engage and disengage from said slider.

In another aspect this invention comprises a method of a method of locking, comprising the steps of;
(a) securing a male section to a first fixture, and wherein said male section has a housing and a channel for a slider;
(b) securing a female section to a second fixture, and wherein said female section has a housing and an opening to receive a portion of said slider; and
(c) using at least one locking mechanism to engage and disengage from said slider.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1, illustrates a perspective view of an inventive advanced lockable latch apparatus in an open position according to a first embodiment of this invention.

FIG. 2, illustrates a perspective view of an inventive advanced lockable latch apparatus in an intermediate position according to a first embodiment of this invention.

FIG. 3, illustrates a perspective view of an inventive advanced lockable latch apparatus in a closed or locked position according to a first embodiment of this invention.

FIG. 4, illustrates a perspective view of an inventive advanced lockable latch apparatus in an open position according to a second embodiment of this invention.

FIG. 5, illustrates a perspective view of an inventive advanced lockable latch apparatus in an intermediate position according to a second embodiment of this invention.

FIG. 6, illustrates a perspective view of an inventive advanced lockable latch apparatus in a closed or locked position according to a second embodiment of this invention.

FIG. 7, illustrates a perspective view of an inventive advanced lockable latch bolt or slider according to a third embodiment of this invention.

FIG. 8, illustrates a perspective view of an inventive advanced lockable latch bolt or slider according to a fourth embodiment of this invention.

FIG. 9, illustrates a perspective view of an inventive advanced lockable latch bolt or slider according to a fifth embodiment of this invention.

FIG. 10, illustrates an enlarged perspective view of the inventive advanced lockable latch apparatus in a locked position according to the first embodiment of this invention.

FIG. 11, illustrates an enlarged perspective view of the inventive advanced lockable latch apparatus in a locked position according to the second embodiment of this invention.

### DETAILED DESCRIPTION

This invention in one aspect is for a mechanism that enables a latch to become not just open or closed but lockable too. This is achieved by modifying either end, or both ends, of the bolt of the latch; and modifying the latch so that the bolt will travel beyond its normal closed position to a now extended locked position; adding a lock and key mechanism to either end, or both ends, of the latch for the bolt to fit into; becoming locked into position with or without key action, depending on the type of lock and key mechanism chosen.

A latch is a device for stopping a door or a window from being opened. It is a popular device because it is easy to install, to use, and can be applied to most types of closeable aperture, such as, a door, or window. This invention adds an innovative feature to enhance its protective capabilities through the introduction of an innovative lock and key mechanism.

The latch device has three main components or parts, namely, a first part which is a bolt with a handle, a second part which is its housing that is fixed to one side of a fixture, such as, for example, a door, or a window, and a third part which is the female aperture that is fixed to the other side of the fixture, such as, a door, a window, a door jam, etc. The first housing part contains the slideable bolt. The bolt slides as far as it can go so that it enters the female aperture, and then it is swiveled, via a half or partial rotation, to a, say a closed position. By modifying the latch so that the bolt may extend further, one or both of its ends suitably modified may enter the aperture of a conventional lock, and become locked rather than simply closed. On entry into the conventional lock and key aperture it becomes fixed due the, for example, the auto-lock mechanism. With this additional feature the invention provides the bolt to now require a key, so that it can be unlocked.

In another embodiment the new latch, along with the addition of the innovative lock and key, one will have one of the following positions: A first position, which would be, for example, an open position, where the bolt will be drawn back inside the housing; A second position, which would be, for example, a closed position, where the bolt will be inside the female aperture only; and a third position which would be, for example, a locked position, where either end of the bolt, or both ends at once is/are extended beyond the normal female aperture position, all the way into the additional lock and key mechanism.

It should be appreciated that a standard door latch does not have an extended locked position; it can be either in a key-less closed or unclosed position, and can be opened without a key as long as there is open access to the latch.

The invention comprises a new position for the bolt to extend to and to become locked as it enters the lock and key mechanism. The bolt or latch can be moved to a closed position, which does not require a key action to open it, an extended position beyond which key action would be now necessary to be able to slide it back to the open position, if it is an automatic locking mechanism.

The invention adds the advantage of being able to open and close the bolt or extend the bolt to a locked position. Therefore, the innovative latch will enhance the security level of a normal conventional latch.

This invention adds several inventive features to enhance a latch so that it becomes not just openable by hand but also lockable with a key.

The invention comprises of a latch having a locking mechanism with a key. Either end of the bolt, or both, may be modified to provide a single or dual lock state for flexibility and additional enhanced protection.

In some embodiments either or both ends of the latch can be clamped or locked and controlled by one or two lock mechanisms and keys.

The insertion of an additional slot in the latch barrel allows it to be clamped or locked in the added extended position.

As the bolt is inserted in the extended locked position the bolt itself is now behind a cover or housing that frustrates forced opening or breakage.

This advanced lockable latch is useful, for example, where a door must be locked and unlocked from the outside and where a latch mechanism is appropriate.

A conventional latch fitted to a door in a frame has a sliding bolt (male) that extends into its (female) counterpart fitted to the door frame itself.

This improved version of a latch allows the bolt to extend even further through its (female) counterpart into the aperture of the added lock and key. The bolt end is modified so that it is identical to the end shape of the original U-bolt of the lock and key, thereby replacing it.

This improved bolt takes the place of the lock and key U-bolt and is locked into it either by turning the key or through self-locking on insertion, depending on the lock and key design.

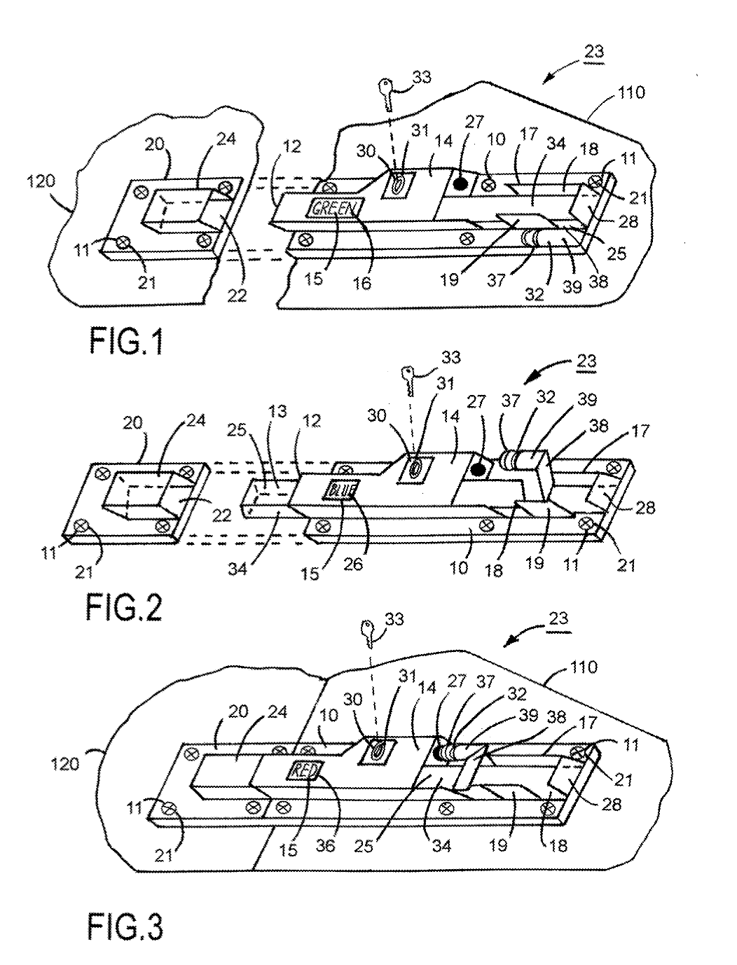

The inventive advanced lockable latch apparatus and a method of using same will now be discussed with reference to FIGS. 1 through 9. Although the scope of the present invention is much broader than any particular embodiment, a detailed description of the preferred embodiment follows together with drawings. These drawings are for illustration purposes only and are not drawn to scale. Like numbers represent like features and components in the drawings.

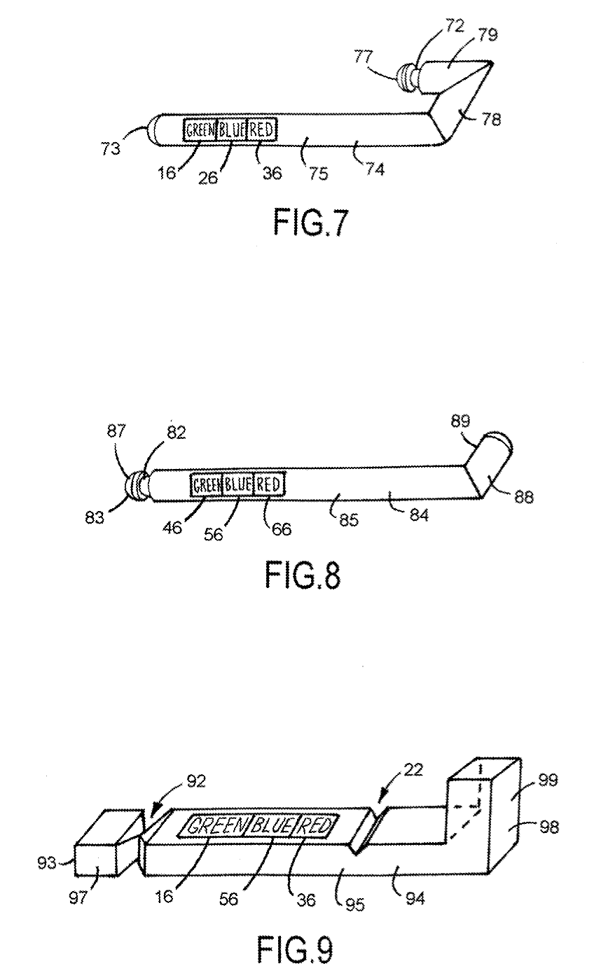

FIG. 1, illustrates a perspective view of an inventive advanced lockable latch apparatus 23, in an open position according to a first embodiment of this invention. The lockable latch 23, comprises of a latch male base 10, and a latch female or striker base 20. The latch male base 10, has a latch male housing 14, secured thereto, and the latch female base 20, has a latch female or striker housing 24, secured thereto. The latch male housing 14, has an opening or hole 12, for the passage of a latch 25, while the latch female housing 24, has an opening or hole 22, for receiving an end portion 13, of the latch 25. A latch channel 18, is formed in the latch male housing 14, comprising the opening or hole 12, a first latch channel wall 17, a second latch channel wall 19, and a latch stop 28. The latch 25, has a latch shaft or slider or bolt 34, with a first end having a latch male end 13, as more clearly shown in FIG. 2, and a second end having a latch elbow 38. Preferably, the latch elbow 38, is at a substantially vertical angle to the slider 34. For some applications, the latch elbow 38, could have a latch handle 39, and a latch knob 37. Latch elbow 38, latch handle 39, and latch knob 37, are used to hold, and slide the bolt 34. For some applications the latch knob 37, having a locking notch 32, as more clearly shown in FIG. 7, as locking notch 72, could be used to close or lock the latch 25. It should be appreciated that once placed inside the latch channel 18, the latch shaft or slider or bolt 34, is free to move back and forth within the latch channel 18. The latch male base 10, has a plurality of openings or holes 11, and through which a securing means 21, is used to secure the latch male base 10, to a first fixture 110. Similarly, the latch female base 20, has a plurality of openings or holes 11, and through which a securing means 21, is used to secure the latch female base 20, to a second fixture 120. For some applications the latch male housing 14, could have an opening or hole 27, for the insertion of a latch knob 37, or a latch handle 39.

The latch male housing 14, has a lock or locking mechanism 30, having an opening or hole 31, for the insertion of a key or a locking device 33. Typically, the key 33, would be inserted into the lock 30, via the hole 31, and then turned either clockwise or counterclockwise, to either engage or disengage the locking mechanism 30, with the latch shaft or slider or bolt 34, of the latch 25. For some applications the key 33, would be inserted into the lock 30, via the hole 31, and then turned either clockwise or counterclockwise, to either engage or disengage the locking mechanism 30, with the latch knob 37, and/or the locking notch 32, of the latch 25. For some applications the locking notch 32, and the latch knob 37, are inserted into the hole or opening 27, within the latch male housing, so that the locking lock or the locking mechanism 30, would engage or disengage with the latch knob 37, and/or the locking notch 32, of the latch 25. Thus it should be appreciated that the rotation of the key 33, within the locking mechanism 30, actuates a locking or an unlocking mechanism within the locking mechanism 30, to engage or disengage the latch engagement member 25, and thereby lock or unlock a fixture 110, 120, such as, a door or window or a panel, etc.

The latch male housing 14, has at least one window 15, for the display of a feature 16, that may be on the surface of the latch 25. For example, the feature 16, could be a color 16, or an indicia 16, to name a few. In FIG. 1, for example, a green color 16, or a green indicia 16, that is on the latch shaft or slider or bolt 34, of the latch 25, is displayed through the window 15.

FIG. 2, illustrates a perspective view of an inventive advanced lockable latch apparatus 23, in an intermediate position according to a first embodiment of this invention. As one can see that the latch shaft or slider or bolt 34, of the latch 25, is penetrating out of the hole or opening 12, and the latch elbow 38, has slid away from the latch stop 28. It should also be appreciated that with the sliding of the slider 34, the indicia 26, that is being displayed through the opening or window 15, also changes, for example, in FIG. 2, a blue color 26, or a blue indicia 26, that is on the latch shaft or slider or bolt 34, of the latch 25, is being displayed through the window 15, in the intermediate position. For the ease of understanding the fixtures 110, and 120, are not being shown, and the latch female or striker base 20, is being shown at a greater distance. However, in reality the latch male end 13, of the latch 25, would be fully or partially penetrating the latch female or striker opening or hole 22.

FIG. 3, illustrates a perspective view of an inventive advanced lockable latch apparatus 23, in a closed or locked position according to a first embodiment of this invention. In the closed position slider 34, of the latch 25, would be fully or substantially penetrating the latch female or striker opening or hole 22, within the latch female or striker housing 24. After the closed position, the next would be a locked position. In a locked position a key or a locking device 33, would be inserted through the opening or hole 31, into the locking mechanism 30, and then the key or the locking device 33, would be rotated either clockwise or counterclockwise to engage the lock or locking mechanism 30, with the latch 25, so as to lock the position of the latch 25, in one place. This locking can be done with engaging the locking mechanism 30, with a locking notch 22, or the locking notch 32, of the latch 25, as more clearly shown in FIG. 7, as locking notch 72, and as a locking notch 22, in FIG. 9. Under the closed or locked conditions the window 15, would display a color 36, or an indicia 36. For example, in FIG. 3, a red color 36, or a red indicia 36, that is on the latch shaft or slider or bolt 34, of the latch 25, is being displayed through the window 15, in the closed or locked position.

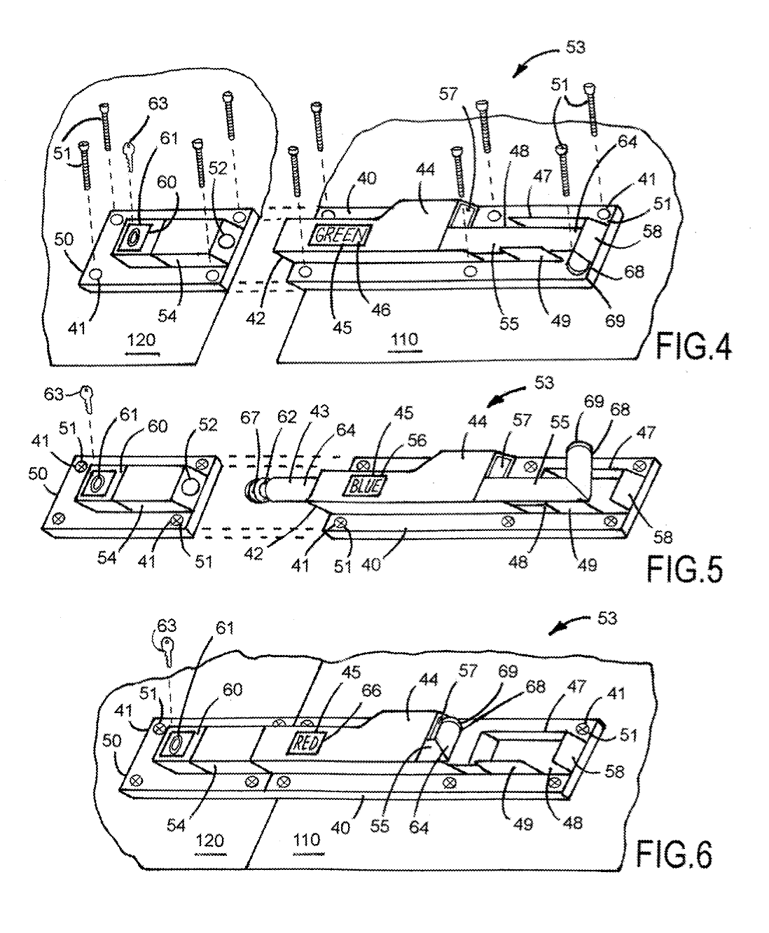

FIG. 4, illustrates a perspective view of an inventive advanced lockable latch apparatus 53, in an open position according to a second embodiment of this invention. The lockable latch 53, comprises of a latch male base 40, and a latch female or striker base 50. The latch male base 40, has a latch male housing 44, secured thereto, and the latch female base 50, has a latch female or striker housing 54, secured thereto. The latch male housing 44, has an opening or hole 42, for the passage of a latch 55, while the latch female housing 54, has an opening or hole 52, for receiving an end portion 43, of the latch 55. A latch channel 48, is formed in the latch male housing 44, comprising the opening or hole 42, a first latch channel wall 47, a second latch channel wall 49, and a latch stop 58. The latch 55, has a latch shaft or slider or bolt 64, with a first end having a latch male end 43, as more clearly shown in FIG. 5, and a second end having a latch elbow 68, and optionally a latch handle 69. Preferably, the latch elbow 68, is at a substantially vertical angle to the slider 64. For some applications, the latch elbow 68, could have a latch handle 39, a latch knob 37, and a locking notch 32. Latch elbow 68, latch handle 39, and latch knob 37, are used to hold, and slide the bolt 64. It should be appreciated that once placed inside the latch channel 48, the latch shaft or slider or bolt 64, is free to move back and forth within the latch channel 48. The latch male base 40, has a plurality of openings or holes 41, and through which a securing means 51, is used to secure the latch male base 40, to a first fixture 110. Similarly, the latch female base 50, has a plurality of openings or holes 41, and through which a securing means 51, is used to secure the latch female base 50, to a second fixture 120. For some applications the latch male housing 44, could have an opening or hole 57, for the insertion of a latch knob 37, or a latch handle 39, or locking notch 32. For some applications the latch male housing 44, will have an opening 57, to hold latch elbow 68, when the latch 55, is locked to protect the latch 55, from being forced to open, such as, for example, using a hammer.

The latch female housing 54, has a lock or locking mechanism 60, having an opening or hole 61, for the insertion of a key or a locking device 63. Typically, the key 63, would be inserted into the lock 60, via the hole 61, and then turned either clockwise or counterclockwise, to either engage or disengage the locking mechanism 60, with the latch shaft or slider or bolt 64, of the latch 55. Thus it should be appreciated that the rotation of the key 63, within the locking mechanism 60, actuates a locking or an unlocking mechanism within the locking mechanism 60, to engage or disengage the latch engagement member 55, and thereby lock or unlock a fixture 110, 120, such as, a door or window or a panel, etc.

The latch male housing 44, has at least one window 45, for the display of a feature 46, that may be on the surface of the latch 55. For example, the feature 46, could be a color 46, or an indicia 46, to name a few. In FIG. 4, for example, a green color 46, or a green indicia 46, that is on the latch shaft or slider or bolt 64, of the latch 55, is displayed through the window 45.

FIG. 5, illustrates a perspective view of an inventive advanced lockable latch apparatus 53, in an intermediate position according to a second embodiment of this invention. As one can see that the latch shaft or slider or bolt 64, of the latch 55, is penetrating out of the hole or opening 42, and the latch elbow 68, has slid away from the latch stop 58. It should also be appreciated that with the sliding of the slider 64, the indicia 56, that is being displayed through the opening or window 45, also changes, for example, in FIG. 5, a blue color 56, or a blue indicia 56, that is on the latch shaft or slider or bolt 64, of the latch 55, is being displayed through the window 45, in the intermediate position. For the ease of understanding the fixtures 110, and 120, are not being shown, and the latch female or striker base 50, is being shown at a greater distance. However, in reality the latch male end 43, of the latch 55, would be fully or partially penetrating the latch female or striker opening or hole 52. For some applications the latch 55, could have a latch knob 67, and/or a latch notch 62, at the latch male end 43. The latch knob 67, of the latch notch 62, would be in an engaged position with the locking mechanism 60.

FIG. 6, illustrates a perspective view of an inventive advanced lockable latch apparatus 53, in a closed or locked position according to a second embodiment of this invention. In the closed position slider 64, of the latch 55, would be fully or substantially penetrating the latch female or striker opening or hole 52, within the latch female or striker housing 54. After the closed position, the next would be a locked position. In a locked position a key or a locking device 63, would be inserted through the opening or hole 61, into the locking mechanism 60, and then the key or the locking device 63, would be rotated either clockwise or counterclockwise to engage the lock or locking mechanism 60, with the latch 55, so as to lock the position of the latch 55, in one place. This locking can be done with engaging the locking mechanism 60, with a locking notch 62, or the locking notch 32, of the latch 55, as more clearly shown in FIGS. 7, as locking notch 72, and locking notch 82, in FIG. 8, and as locking notch 22, 92, as shown in FIG. 9. Under the closed or locked conditions the window 45, would display a color 66, or an indicia 66. For example, in FIG. 6, a red color 66, or a red indicia 66, that is on the latch shaft or slider or bolt 64, of the latch 55, is being displayed through the window 45, in the closed or locked position. For some applications, in the locked condition the elbow 68, will be inside the opening 57, to protect the latch from being forced, such as, with a hammer.

FIG. 7, illustrates a perspective view of an inventive advanced lockable latch bolt or slider 75, according to a third embodiment of this invention. The latch bolt or slider 75, has a latch shaft 74, with a first end having a latch male end 73, and a second end having a latch elbow 78. Preferably, the latch elbow 78, is at a substantially vertical angle to the latch shaft 74. For some applications, the latch elbow 78, could have a latch handle 79, a latch knob 77, and a locking notch 72. Latch elbow 78, latch handle 79, and latch knob 77, are used to hold, and slide the slider 75. For some applications the latch knob 77, having a locking notch 72, could be used to close or lock the latch 75, as discussed earlier. For some applications the latch 75, could also have a locking notch 22, as shown in FIG. 9, which could be used to engage or be disengaged from a locking mechanism, such as, locking mechanism 30, 60. The latch 75, preferably has a plurality of indicators, such as, indicators 16, 26, 36, 46, 56, 66, etc., to indicate the position of the latch 75, within a lockable latch 23, 53, such as, for example, open, intermediate, closed, locked, etc.

FIG. 8, illustrates a perspective view of an inventive advanced lockable latch bolt or slider 85, according to a fourth embodiment of this invention. The latch bolt or slider 85, has a latch shaft 84, with a first end having a latch male end 83, and a second end having a latch elbow 88. Preferably, the latch elbow 88, is at a substantially vertical angle to the latch shaft 84. The latch elbow 88, can be used to hold, and slide the slider or latch 85. For some applications the latch male end 83, could have a latch knob 87, having a locking notch 82, which could be used to close or lock the latch 85, as discussed earlier. The latch 85, having the locking notch 82, could be used to engage or be disengaged from a locking mechanism, such as, locking mechanism 30, 60. The latch 85, preferably has a plurality of indicators, such as, indicators 16, 26, 36, 46, 56, 66, etc., to indicate the position of the latch 85, within a lockable latch 23, 53, such as, for example, open, intermediate, closed, locked, etc.

FIG. 9, illustrates a perspective view of an inventive advanced lockable latch bolt or slider 95, according to a fifth embodiment of this invention. The latch bolt or slider 95, has a latch shaft 94, with a first end having a latch male end 93, and a second end having a latch elbow 98. Preferably, the latch elbow 98, is at a substantially vertical angle to the latch shaft 94. The latch elbow 98, can be used to hold, and slide the slider or latch 95. For some applications the latch male end 93, could have a latch knob 97, having a locking notch 92, which could be used to close or lock the latch 95, as discussed earlier. The latch 95, having the locking notch 92, could be used to engage or be disengaged from a locking mechanism, such as, locking mechanism 30, 60. The latch 95, preferably has a plurality of indicators, such as, indicators 16, 26, 36, 46, 56, 66, etc., to indicate the position of the latch 95, within a lockable latch 23, 53, such as, for example, open, intermediate, closed, locked, etc.

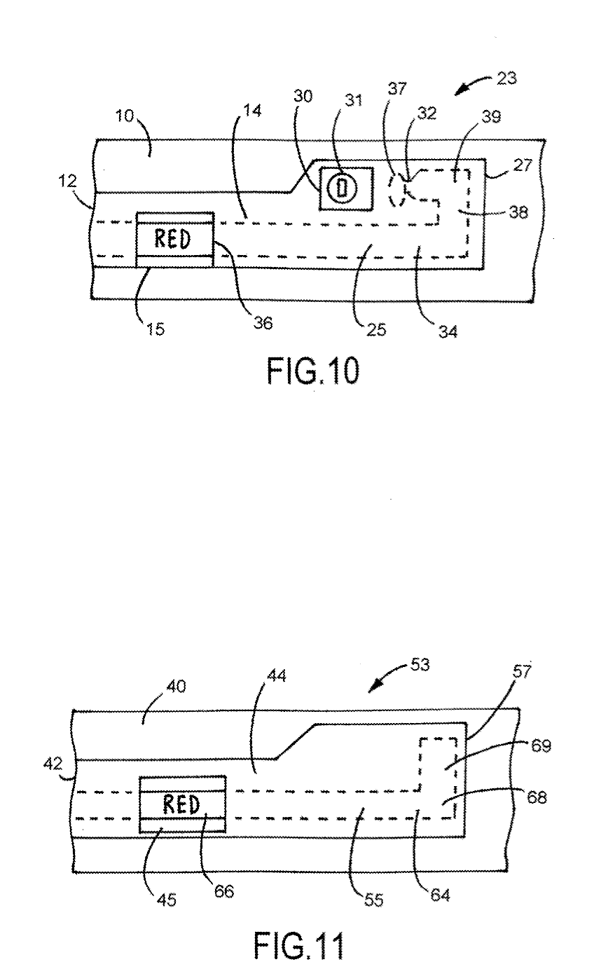

FIG. 10, illustrates an enlarged perspective view of the inventive advanced lockable latch apparatus 23, in a locked position according to the first embodiment of this invention. As one can see that for some applications the elbow latch 38, along with the latch handle 39, is pushed inside the opening or hole 27, in the latch male housing 14, and then locked there in place using a the lock or locking mechanism 30, such that the latch 25, is not visible nor accessible. In such a situation the latch 25, once locked in place inside the latch male housing 14, would only slide out or be ejected by the use of the key 33, which would eject the latch 25, along with the latch handle 39, towards the outside of the hole or opening 27. The lock or the locking mechanism 30, could have a mechanical type device or a spring mechanism or some other engagement and disengagement feature that is used to either lock the latch 25, in place, or eject it towards an open position. Thus, in this locked position the latch handle 39, is not even accessible to a hammer or to any other tool to pry it out of the opening 27, as it is being protected by the latch male housing 14.

FIG. 11, illustrates an enlarged perspective view of the inventive advanced lockable latch apparatus 53, in a locked position according to the second embodiment of this invention. As one can see that for some applications the elbow latch 68, along with the latch handle 69, is pushed inside the opening or hole 57, in the latch male housing 44, and then locked there in place using a the lock or locking mechanism 60, such that the latch 55, is not visible nor accessible. In such a situation the latch 55, once locked in place inside the latch male housing 44, would only slide out or be ejected by the use of the key 63, which would eject the latch 55, along with the latch handle 69, towards the outside of the hole or opening 57. The lock or the locking mechanism 60, could have a mechanical type device or a spring mechanism or some other engagement and disengagement feature that is used to either lock the latch 55, in place, or eject it towards an open position. Thus, in this locked position the latch handle 69, is not even accessible to a hammer or to any other tool to pry it out of the opening 57, as it is being protected by the latch male housing 44.

The cross-sectional area for the inventive slider 34, 64, 74, 84, 94, of the latch 25, 55, 75, 85, 95, can be selected from a group comprising a triangle, a square, a rectangle, a circle, an oval, a polygonal shape, a cylindrical shape, and combinations thereof, to name a few.

The material for the inventive latch 23, 53, or the inventive bolt or slider 25, 55, 75, 85, 95, could be selected from a group comprising iron, brass, nickel, copper, metal, aluminum, plastic, stainless steel, a composite material, and combinations thereof, to name a few.

The first fixture 110, and the second fixture 120, could be selected from a group comprising door, window, door jamb, panel, lid, and combinations thereof, to name a few.

It should be understood that the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and apparatuses described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A locking apparatus, comprising;
(a) a male section having a housing and a channel for a slider;
(b) a female section having a housing and an opening to receive a portion of said slider; and
(c) a locking mechanism to engage and disengage from said slider.

2. The apparatus of claim 1, wherein material for said male section and said female section is selected from a group consisting of metal, aluminum, plastic, stainless steel, a composite material, and combination thereof.

3. The apparatus of claim 1, wherein cross-sectional area for said slider is selected from a group consisting of a triangle, a square, a rectangle, a circle, an oval, a polygonal shape, a cylindrical shape, and combinations thereof.

4. The apparatus of claim 1, wherein material for said slider is selected from a group consisting of metal, aluminum, plastic, stainless steel, a composite material, and combination thereof.

5. The apparatus of claim 1, wherein said locking mechanism has an opening, and wherein a key is inserted through said opening to activate said locking mechanism to engage with and securely hold said slider in a stationary position.

6. The apparatus of claim 1, wherein said locking mechanism has an opening, and wherein a key is inserted through said opening to deactivate said locking mechanism and to disengage said locking mechanism from said slider.

7. The apparatus of claim 1, wherein said slider has marking on its upper surface, and wherein said marking is selected from a group consisting of color coding, indicia, letters, alphabets, braille, and combinations thereof.

8. The apparatus of claim 1, wherein said male housing has at least one opening for the display of at least one marking, and wherein said at least one marking is on the surface of said slider.

9. The apparatus of claim 1, wherein said female housing has at least one opening for the display of at least one marking, and wherein said at least one marking is on the surface of said slider.

10. The apparatus of claim 1, wherein said male housing has at least one opening for receiving and securely locking an end of said slider within said housing.

11. A method of locking, comprising the steps of;
(a) securing a male section to a first fixture, and wherein said male section has a housing and a channel for a slider;
(b) securing a female section to a second fixture, and wherein said female section has a housing and an opening to receive a portion of said slider; and
(c) using at least one locking mechanism to engage and disengage from said slider.

12. The method of locking of claim 11, wherein material for said male section and said female section is selected from a group consisting of metal, aluminum, plastic, stainless steel, a composite material, and combination thereof.

13. The method of locking of claim 11, wherein cross-sectional area for said slider is selected from a group consisting of a triangle, a square, a rectangle, a circle, an oval, a polygonal shape, a cylindrical shape, and combinations thereof.

14. The method of locking of claim 11, wherein material for said slider is selected from a group consisting of metal, aluminum, plastic, stainless steel, a composite material, and combination thereof.

15. The method of locking of claim 11, wherein said locking mechanism has an opening, and wherein a key is inserted through said opening to activate said locking mechanism to engage with and securely hold said slider in a stationary position.

16. The method of locking of claim 11, wherein said locking mechanism has an opening, and wherein a key is inserted through said opening to deactivate said locking mechanism and to disengage said locking mechanism from said slider.

17. The method of locking of claim 11, wherein said slider has marking on its upper surface, and wherein said marking is selected from a group consisting of color coding, indicia, letters, alphabets, braille, and combinations thereof.

18. The method of locking of claim 11, wherein said male housing has at least one opening for the display of at least one marking, and wherein said at least one marking is on the surface of said slider.

19. The method of locking of claim 11, wherein said female housing has at least one opening for the display of at least one marking, and wherein said at least one marking is on the surface of said slider.

20. The method of locking of claim 11, wherein said male housing has at least one opening for receiving and securely locking an end of said slider within said housing.
